(19) United States
(12) Patent Application Publication
(10) Pub. No.: US 2025/0103861 A1
(43) Pub. Date: Mar. 27, 2025

(54) TRAINING A NODE OF A TWO-SIDED MODEL

(71) Applicant: Lenovo (Singapore) Pte. Limited, Singapore (SG)

(72) Inventors: Vahid Pourahmadi, München (DE); Ahmed Hindy, Aurora, IL (US); Vijay Nangia, Woodridge, IL (US); Venkata Srinivas Kothapalli, Ottawa (CA)

(73) Assignee: Lenovo (Singapore) Pte. Limited, Singapore (SG)

(21) Appl. No.: 18/894,754

(22) Filed: Sep. 24, 2024

Related U.S. Application Data
(60) Provisional application No. 63/540,507, filed on Sep. 26, 2023.

(51) Int. Cl. G06N 3/0455

(52) U.S. Cl. CPC G06N 3/0455

(57) ABSTRACT

Various aspects of the present disclosure relate to training a node of a two-sided model. When a new user equipment (UE) side node is added to a two-sided model, training information representing a trained model is received (e.g., from the network side). An encoder model for the UE is trained based at least in part on the training information and, once trained, the UE transmits data encoded at the UE using the trained encoder model. When a new network (e.g., base station) side node is added to the two-sided model, training information associated with one or more UEs is received. A decoder model for the base station is trained based at least in part on the training information and, once trained, the base station uses the trained decoder model to decode data encoded at and received from UE.

### RELATED APPLICATION

This application claims priority to U.S. Patent Application Ser. No. 63/540,507 filed Sep. 26, 2023 entitled “TRAINING A NODE OF A TWO-SIDED MODEL,” the disclosure of which is incorporated by reference herein in its entirety.

### TECHNICAL FIELD

The present disclosure relates to wireless communications, and more specifically to two-sided models.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, a two-sided model includes a UE side and a network (e.g., next-generation NodeB (gNB)) side. Common techniques used to determine whether the two-sided model is performing appropriately include comparing an output of the gNB side of the model with the input at the UE side of the model.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a first node for wireless communication. The first node sends, to at least one network node, a first signaling indicating a request for training information that represents a trained model at a set of one or more base stations; receives, from the at least one network node, at least one second signaling indicating the training information; and transmits, to a base station of the set of one or more base stations, a third signaling indicating data encoded at the first node using an encoder trained based at least in part on the training information.

In some implementations of the method and apparatuses described herein, the first node comprises a UE. Additionally or alternatively, the encoder is trained using a local decoder at the first node, the local decoder having been trained using the training information. Additionally or alternatively, the request contains information to identify the base stations included in the set of one or more base stations from which the first node wants to receive the training information. Additionally or alternatively, the at least one network node includes the set of one or more base stations. Additionally or alternatively, the first node combines the training information for multiple base stations of the set of one or more base stations, the encoder being trained based at least in part on the combined training information. Additionally or alternatively, the training information includes at least one of a set of samples representing an input and an output of a decoder model of a two-sided model that includes the encoder, or characterizing information regarding the decoder model of the two-sided model. Additionally or alternatively, the first node trains, using the training information, a local decoder model to represent the decoder model of the two-sided model, and the encoder is trained using the local decoder model. Additionally or alternatively, a first set of parameters of the encoder is determined such that the encoder sequentially combined with the trained local decoder model constructs an additional two-sided model that can generate input/output pairs similar to the input and the output. Additionally or alternatively, the training information includes at least one of a set of samples representing an input and an output of a local encoder model, which performs as an encoder model of a local two-sided model of a base station, or characterizing information regarding the local encoder model. Additionally or alternatively, a first set of parameters of the encoder model is determined such that the trained encoder model generates similar input/output pairs to input/output pairs generated by the local encoder model associated with the base station. Additionally or alternatively, the first set of parameters comprises at least one of a structure or a weight of at least one neural network model. Additionally or alternatively, the first set of parameters comprises at least one of a structure or a weight of at least one neural network model.

Some implementations of the method and apparatuses described herein may further include a first node for wireless communication. The first node sends, to at least one network node, a first signaling indicating a request for training information associated with a set of one or more UEs; receives, from the at least one network node, at least one second signaling indicating the training information; receives, from a first UE of the set of one or more UEs, a third signaling indicating data encoded at the first UE; and decodes, using a decoder trained based at least in part on the training information, the data encoded at the first UE.

In some implementations of the method and apparatuses described herein, the first node comprises a base station. Additionally or alternatively, the decoder is trained using a local encoder at the first node, the local encoder having been trained using the training information, the request contains information to identify the UEs included in the set of one or more UEs from which the first node wants to receive the training information. Additionally or alternatively, the at least one network node includes the set of one or more UEs. Additionally or alternatively, the first node combines the training information for multiple UEs of the set of one or more UEs, the decoder being trained based at least in part on the combined training information. Additionally or alternatively, the training information includes at least one of a set of samples representing an input and an output of an encoder model of a two-sided model that includes the decoder, or characterizing information regarding the encoder model of the two-sided model. Additionally or alternatively, the first node trains, using the training information, a local encoder model to represent the encoder model of the two-sided model, and the decoder is trained using the local encoder model. Additionally or alternatively, a first set of parameters of the encoder is determined such that the encoder sequentially combined with the trained local decoder model constructs an additional two-sided model that can generate input/output pairs similar to the input and the output. Additionally or alternatively, the training information includes at least one of a set of samples representing an output of an encoder model of a two-sided model and an expected output of a decoder model of the two-sided model. Additionally or alternatively, a first set of parameters of the encoder model is determined such that the trained decoder model generates similar input/output pairs to input/output pairs included in the training information. Additionally or alternatively, the first set of parameters comprises at least one of a structure or a weight of at least one neural network model. Additionally or alternatively, the first set of parameters comprises at least one of a structure or a weight of at least one neural network model.

Some implementations of the method and apparatuses described herein may further include a processor for wireless communication. The processor sends, to at least one network node, a first signaling indicating a request for training information that represents a trained model at a set of one or more base stations; receives, from the at least one network node, at least one second signaling indicating the training information; and transmits, to a base station of the set of one or more base stations, a third signaling indicating data encoded at the processor using an encoder trained based at least in part on the training information.

In some implementations of the method and apparatuses described herein, the processor is implemented in a UE. Additionally or alternatively, the encoder is trained using a local decoder at a first node that includes the processor, the local decoder having been trained using the training information. Additionally or alternatively, the request contains information to identify the base stations included in the set of one or more base stations from which the a first node that includes the processor wants to receive the training information. Additionally or alternatively, the at least one network node includes the set of one or more base stations. Additionally or alternatively, the processor combines the training information for multiple base stations of the set of one or more base stations, the encoder being trained based at least in part on the combined training information. Additionally or alternatively, the training information includes at least one of a set of samples representing an input and an output of a decoder model of a two-sided model that includes the encoder, or characterizing information regarding the decoder model of the two-sided model. Additionally or alternatively, the processor trains, using the training information, a local decoder model to represent the decoder model of the two-sided model, and the encoder is trained using the local decoder model. Additionally or alternatively, a first set of parameters of the encoder is determined such that the encoder sequentially combined with the trained local decoder model constructs an additional two-sided model that can generate input/output pairs similar to the input and the output. Additionally or alternatively, the training information includes at least one of a set of samples representing an input and an output of a local encoder model, which performs as an encoder model of a local two-sided model of a base station, or characterizing information regarding the local encoder model. Additionally or alternatively, a first set of parameters of the encoder model is determined such that the trained encoder model generates similar input/output pairs to input/output pairs generated by the local encoder model associated with the base station. Additionally or alternatively, the first set of parameters comprises at least one of a structure or a weight of at least one neural network model. Additionally or alternatively, the first set of parameters comprises at least one of a structure or a weight of at least one neural network model.

Some implementations of the method and apparatuses described herein may further include a method performed by a first node, the method comprising: sending, to at least one network node, a first signaling indicating a request for training information that represents a trained model at a set of one or more base stations; receiving, from the at least one network node, at least one second signaling indicating the training information; and transmitting, to a base station of the set of one or more base stations, a third signaling indicating data encoded at the first node using an encoder trained based at least in part on the training information.

In some implementations of the method and apparatuses described herein, the first node comprises a UE. Additionally or alternatively, the encoder is trained using a local decoder at the first node, the local decoder having been trained using the training information. Additionally or alternatively, the request contains information to identify the base stations included in the set of one or more base stations from which the first node wants to receive the training information. Additionally or alternatively, the at least one network node includes the set of one or more base stations. Additionally or alternatively, the method further comprises combining the training information for multiple base stations of the set of one or more base stations, the encoder being trained based at least in part on the combined training information. Additionally or alternatively, the training information includes at least one of a set of samples representing an input and an output of a decoder model of a two-sided model that includes the encoder, or characterizing information regarding the decoder model of the two-sided model. Additionally or alternatively, the method further comprises training, using the training information, a local decoder model to represent the decoder model of the two-sided model, and the encoder is trained using the local decoder model. Additionally or alternatively, a first set of parameters of the encoder is determined such that the encoder sequentially combined with the trained local decoder model constructs an additional two-sided model that can generate input/output pairs similar to the input and the output. Additionally or alternatively, the training information includes at least one of a set of samples representing an input and an output of a local encoder model, which performs as an encoder model of a local two-sided model of a base station, or characterizing information regarding the local encoder model. Additionally or alternatively, a first set of parameters of the encoder model is determined such that the trained encoder model generates similar input/output pairs to input/output pairs generated by the local encoder model associated with the base station. Additionally or alternatively, the first set of parameters comprises at least one of a structure or a weight of at least one neural network model. Additionally or alternatively, the first set of parameters comprises at least one of a structure or a weight of at least one neural network model.

Some implementations of the method and apparatuses described herein may further include a method comprising: sending, to at least one network node, a first signaling indicating a request for training information associated with a set of one or more UEs; receiving, from the at least one network node, at least one second signaling indicating the training information; receiving, from a first UE of the set of one or more UEs, a third signaling indicating data encoded at the first UE; and decoding, using a decoder trained based at least in part on the training information, the data encoded at the first UE.

In some implementations of the method and apparatuses described herein, the first node comprises a base station. Additionally or alternatively, the decoder is trained using a local encoder at the first node, the local encoder having been trained using the training information. Additionally or alternatively, the request contains information to identify the UEs included in the set of one or more UEs from which the first node wants to receive the training information. Additionally or alternatively, the at least one network node includes the set of one or more UEs. Additionally or alternatively, the method further comprises combining the training information for multiple UEs of the set of one or more UEs, the decoder being trained based at least in part on the combined training information. Additionally or alternatively, the training information includes at least one of a set of samples representing an input and an output of an encoder model of a two-sided model that includes the decoder, or characterizing information regarding the encoder model of the two-sided model. Additionally or alternatively, the method further comprises training, using the training information, a local encoder model to represent the encoder model of the two-sided model, and the decoder is trained using the local encoder model. Additionally or alternatively, a first set of parameters of the encoder is determined such that the encoder sequentially combined with the trained local decoder model constructs an additional two-sided model that can generate input/output pairs similar to the input and the output. Additionally or alternatively, the training information includes at least one of a set of samples representing an output of an encoder model of a two-sided model and an expected output of a decoder model of the two-sided model. Additionally or alternatively, a first set of parameters of the encoder model is determined such that the trained decoder model generates similar input/output pairs to input/output pairs included in the training information. Additionally or alternatively, the first set of parameters comprises at least one of a structure or a weight of at least one neural network model. Additionally or alternatively, the first set of parameters comprises at least one of a structure or a weight of at least one neural network model.

### BRIEF DESCRIPTION OF THE DRAWINGS

FIG. 1 illustrates an example of a wireless communications system in accordance with aspects of the present disclosure.

FIG. 2 illustrates an example of a wireless network including a gNB (e.g., a base station) and multiple UEs, as related to training a node of a two-sided model.

FIG. 3 illustrates an example of a high-level structure of a two-sided model, as related to training a node of a two-sided model in accordance with aspects of the present disclosure.

FIG. 4 illustrates an example of another high-level structure of a two-sided model with multiple encoders, as related to training a node of a two-sided model in accordance with aspects of the present disclosure.

FIG. 5 illustrates an example of another high-level structure of a two-sided model with multiple encoders and multiple decoders, as related to training a node of a two-sided model in accordance with aspects of the present disclosure.

FIGS. 6a and 6b illustrate an example of a system, with a UE subsystem and a network subsystem that supports operation of a two-sided model, as related to training a node of a two-sided model in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a network equipment (NE) in accordance with aspects of the present disclosure.

FIG. 10 illustrates a flowchart of a method performed by a UE in accordance with aspects of the present disclosure.

FIG. 11 illustrates a flowchart of a method performed by a NE in accordance with aspects of the present disclosure.

### DETAILED DESCRIPTION

A wireless communications system includes a two-sided model with a UE side and a network (e.g., gNB) side. Data or information is encoded at the UE side using an encoder model, transmitted to the network side, and decoded at the network side using a decoder model. The parameters of a two-sided model (e.g., at least one of a structure or a weight of at least one neural network model) are trained before the two-sided model can effectively provide the data or information to the network side. The model is trained by presenting a set of input and desired output to the model (the training data set), which the model uses to find the statistics of the input and the input/output relation, and capture that in the parameters of the model.

Situations can arise in which the two-sided model includes one or both of multiple encoder models or multiple decoder models. For example, each of multiple UEs (each having an encoder model) may communicate with each of multiple base stations (each having a decoder model). The techniques discussed herein allow additional UEs or base stations to be added to a previously trained two-sided model. For example, a two-sided model may include five UEs (each having a trained encoder model) may be able to communicate with four base stations (each having a trained decoder model). The techniques discussed herein allow a sixth UE to be added to the two-sided model and training the encoder model of the sixth UE based on the already trained decoder models of one or more of the four base stations.

When a new UE is added to the two-sided model, training information representing a trained model is received (e.g., from the network side). An encoder model for the UE is trained based at least in part on the training information. The encoder model can be trained at the UE or at another (e.g., network) node. The training information can take various forms, such as a set of samples representing the input and the output of a decoder model of the two-sided model, characterizing information (e.g., at least one of a structure or a weight of at least one neural network model) regarding a decoder model of the two-sided model, and so forth. Once trained, the UE transmits data encoded at the UE using the trained encoder model.

When a new base station is added to the two-sided model, training information associated with one or more UEs is received. A decoder model for the base station is trained based at least in part on the training information. The decoder model can be trained at the base station or at another (e.g., network) node. The training information can take various forms, such as a set of samples representing the input and the output of an encoder model of the two-sided model, characterizing information (e.g., at least one of a structure or a weight of at least one neural network model) regarding an encoder model of the two-sided model, and so forth. Once trained, the base station uses the trained decoder model to decode data encoded at and received from UE.

The techniques discussed herein allow a newly added node (e.g., UE side or a network (e.g., gNB) side node) to be trained based on an already trained model. When adding a newly added node on one side of the two-sided model, rather than training the encoder models and decoder models of all nodes in the two-sided model, a portion of the model at the newly added node is trained based on training information associated with the other side of the model. All of the nodes including an encoder model or decoder model of the two-sided model do not need to be retrained from scratch (e.g., a default state), which reduces the complexity in the two-sided model of adding in a new node, as well avoids the overhead and delay of training the encoder or decoder models of all of the nodes. Furthermore, the encoder or decoder model of the newly added node is trained using a separate training/model update where the two sides of the two-sided model are trained in different sessions. This allows the model encoder or decoder model of the newly added node to be trained without being aware of the internal structure of the decoder model or encoder model of the other side of the two-sided model.

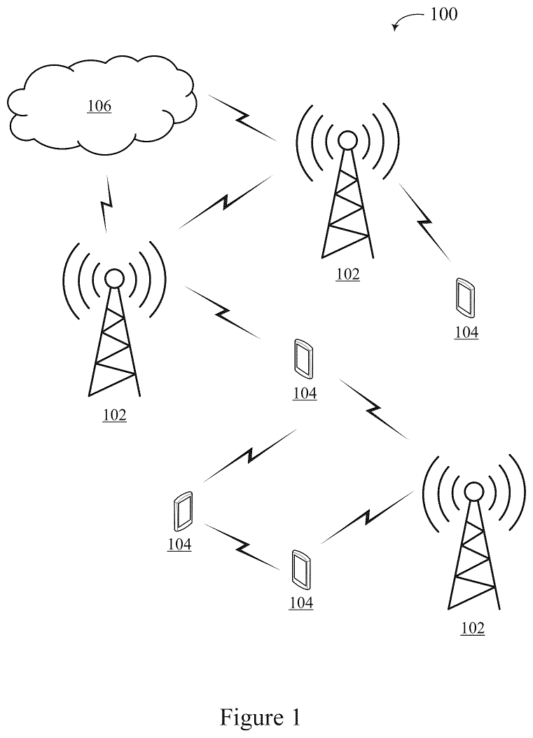

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 includes a two-sided model with a UE side (e.g., at a UE 104) and a network side (e.g., at a NE 102). Data or information is encoded at the UE side using an encoder model, transmitted to the network side, and decoded at the network side using a decoder model. When a new UE 104 is added to the two-sided model, training information representing a trained model is received (e.g., from the NE 102). An encoder model for the UE 104 is trained based at least in part on the training information. The encoder model can be trained at the UE 104 or at another (e.g., network) node (e.g., at the CN 106). The training information can take various forms, such as a set of samples representing the input and the output of a decoder model of the two-sided model, characterizing information (e.g., at least one of a structure or a weight of at least one neural network model) regarding a decoder model of the two-sided model, and so forth. Once trained, the UE 104 transmits data encoded at the UE 104 to the NE 102 using the trained encoder model.

When a new NE 102 is added to the two-sided model, training information associated with one or more UEs 104 is received. A decoder model for the NE 102 is trained based at least in part on the training information. The decoder model can be trained at the NE 102 or at another node (e.g., at the CN 106). The training information can take various forms, such as a set of samples representing the input and the output of an encoder model of the two-sided model, characterizing information (e.g., at least one of a structure or a weight of at least one neural network model) regarding an encoder model of the two-sided model, and so forth. Once trained, the NE 102 uses the trained decoder model to decode data encoded at and received from the UE 104.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

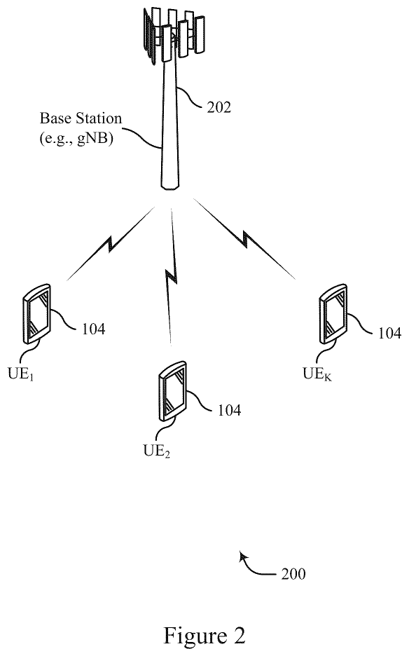

FIG. 2 illustrates an example 200 of a wireless network including a gNB (e.g., a base station) and multiple UEs, as related to training a node of a two-sided model. In this example 200, the wireless network includes a gNB 202 (e.g., a base station, NE 102) and multiple (K) UEs 104. The UEs, for instance, include a UE₁, UE₂, and UE_{K}. The base station can be represented as a node B₁ equipped with M antennas and the K UEs denoted by U₁, U₂, . . . , U_{K} with each having N antennas. In this example, Hₗ^{k} (t) can denote a channel at time t over a frequency band l, l∈{1, 2, . . . , L}, between B₁ and Uₖ which is a matrix of size N×M with complex entries, i.e., Hₗ^{k} (t)∈ [symbol] ^{N×M}.

At time t and frequency band 1, it can be assumed that the base station is to transmit a message xₗ^{k}(t) to U_{K}, where K={1, 2, . . . , K} while the base station uses wₗ^{k} (t)∈ [symbol] ^{M×1} as the precoding vector. The received signal at Uₖ, yₗ^{k} (t), can be indicated as:

[symbol]

$${y}_{l}^{k} ( t ) = {H}_{l}^{k} ( t ) {w}_{l}^{k} ( t ) {x}_{l}^{k} ( t ) + {n}_{l}^{k} ( t )$$

where nₗ^{k}(t) represents the noise vector at the receiver.

To improve the achievable rate of the link, the gNB 202 can select wₗ^{k}(t) that maximizes the received signal-to-noise ratio (SNR). Several schemes have been proposed for selection of wₗ^{k} (t) where some rely on having some knowledge about Hₗ^{k} (t). The gNB can obtain knowledge of Hₗ^{k} (t) by direct measurement (e.g., in time-division duplexing (TDD) mode and assuming reciprocity of the channel), or indirectly using information that a UE sends to the gNB (e.g., in frequency-division duplexing (FDD) mode). In the latter case, a large amount of feedback may be needed to send accurate information about Hₗ^{k} (t), which is important for a large number of antennas and/or large frequency bands.

As described herein, implementations are discussed with reference to a single time slot. However, implementations of the described techniques can be further extended to more than a single time slot. Thus, Hₗ^{k} (t) can be denoted using Hₗ^{k}. The H^{k}(t) can be defined as matrix of size N×M×L which can be composed by stacking Hₗ^{k} for multiple frequency bands (e.g., the entries at H^{k} [n, m, l] can be equal to Hₗ^{k} [n, m]). Thus, each UE can be feeding back the information about the N×M×L complex numbers to the gNB.

Several proposed schemes attempt to reduce the rate of required feedback. For instance, a group of these schemes, generally referred to as two-sided methods, include two parts where a first part is deployed at the UE side and the second part is deployed at the gNB side. In implementations to reduce the required feedback information, an encoding part (at the UE) computes a quantized latent representation of the input data, and the decoding part (at the gNB) gets this latent representation and uses that to reconstruct the desired output. The input data in this case can be data which is based on the channel measurements. For example, it could be the raw channel inputs of H^{k} or Hₗ^{k}, or for example, the precoders that are computed from the channel matrix (e.g., the eigenvector associated to the largest eigen-vector of H^{k} for each sub-band).

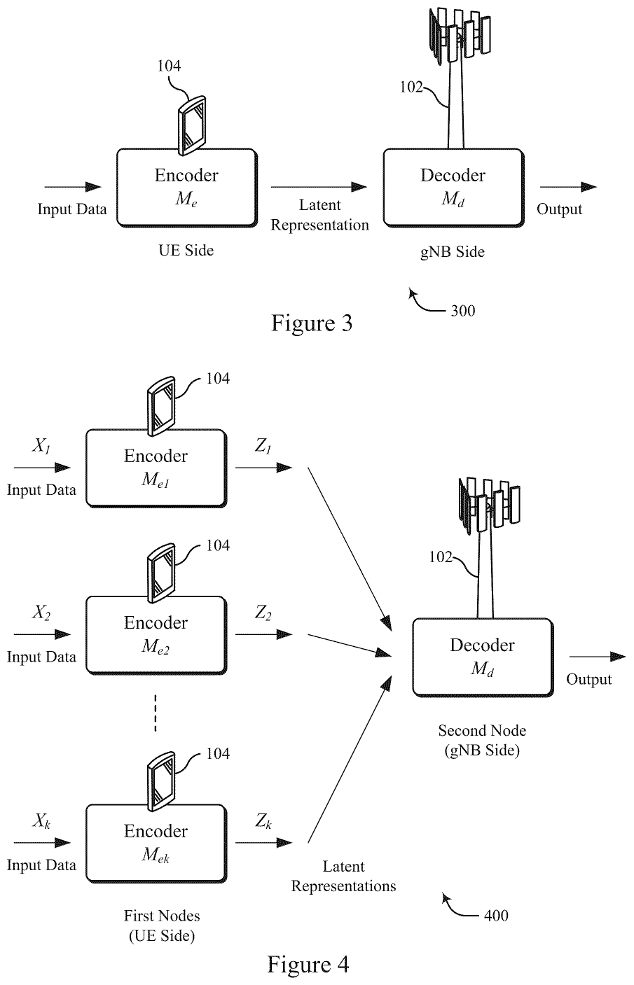

FIG. 3 illustrates an example 300 of a high-level structure of a two-sided model, as related to training a node of a two-sided model in accordance with aspects of the present disclosure. In this example 300, the two-sided model includes a neural network-based UE 104 (e.g., a first node) and a gNB 102 (e.g., a second node) referred to in this example as Mₑ (encoder or encoding model) and M_{d} (decoder or decoding model), respectively.

There are several methods to train the neural network (NN) modules of a two-sided model, including centralized training, simultaneous training and separate training. Similarly, updating a two-sided model can be carried out centrally on one entity, on different entities but simultaneously, or separately.

In separate training/model update, which is the focus of the discussion herein, the NN modules of the first node (e.g., UE) and the second node (e.g., gNB) are trained in different training sessions (no forward or backpropagation path between the two parts). One advantage of the separate training is that the first and the second node does not need to be aware of the internal structure of the NN module of the other side.

One extension of the above is to train the encoder and decoder parts of the two-sided model when there are multiple first nodes (e.g., multiple UEs) and single second nodes.

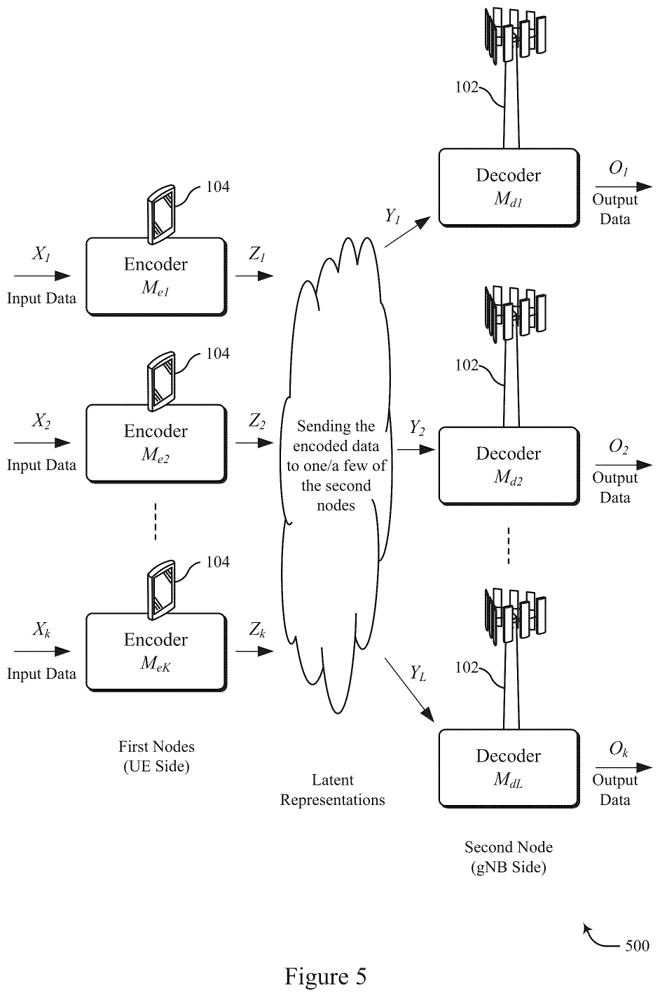

FIG. 4 illustrates an example 400 of another high-level structure of a two-sided model with multiple encoders, as related to training a node of a two-sided model in accordance with aspects of the present disclosure. In implementation extensions of the two-sided model (as shown and described with reference to FIG. 3), the encoders of the different first nodes are similar or different. In this example 400, the two-sided model includes multiple neural network-based UEs 104 (e.g., first nodes, encoders Mₑ) and the gNB 102 (e.g., a second node, decoder M_{d}). In implementations, the structure of the UE side and/or the gNB side can vary depending on the particular two-sided model and scheme. Alternatively, a similar structure can be implemented with multiple decoders (e.g., at multiple gNBs) with a single encoder (e.g., at a UE). With such a structure, the encoders of the first node can work with all decoders and the decoders of the second nodes can be similar or different.

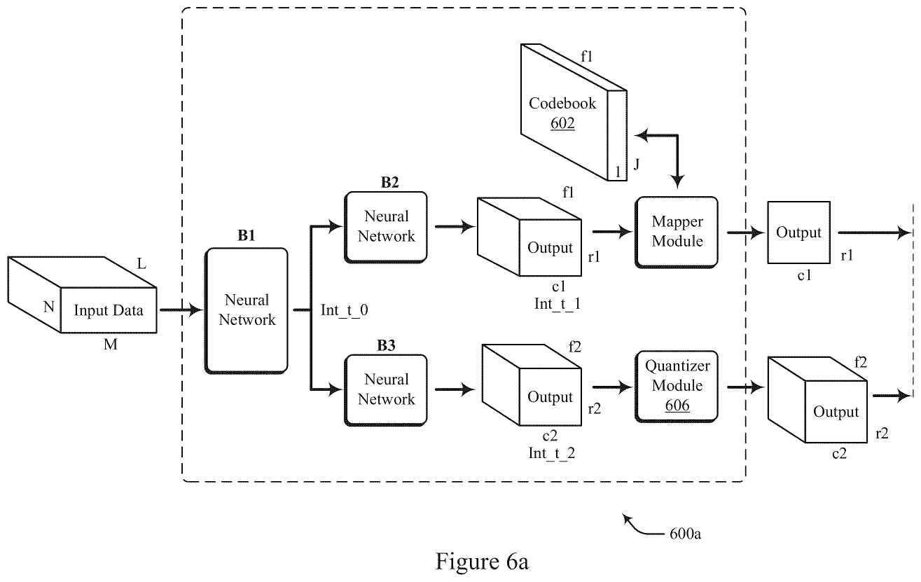

FIG. 5 illustrates an example 500 of another high-level structure of a two-sided model with multiple encoders and multiple decoders, as related to training a node of a two-sided model in accordance with aspects of the present disclosure. In this example 500, the two-sided model includes multiple neural network-based UEs 104 (e.g., first nodes, encoders Mₑ) and multiple neural network-based gNBs 102 (e.g., second nodes, decoders M_{d}). In implementations, the encoder of each of the first nodes encode the data such that any of the second nodes that the particular first node is connected to can decode it using its decoder. Also, the decoder of each of the second nodes can decode the data it receives from the encoder of the first nodes that the particular second node is connected to.

The exact structure of the UE 104 and gNB 102 side can vary depending on the particular scheme.

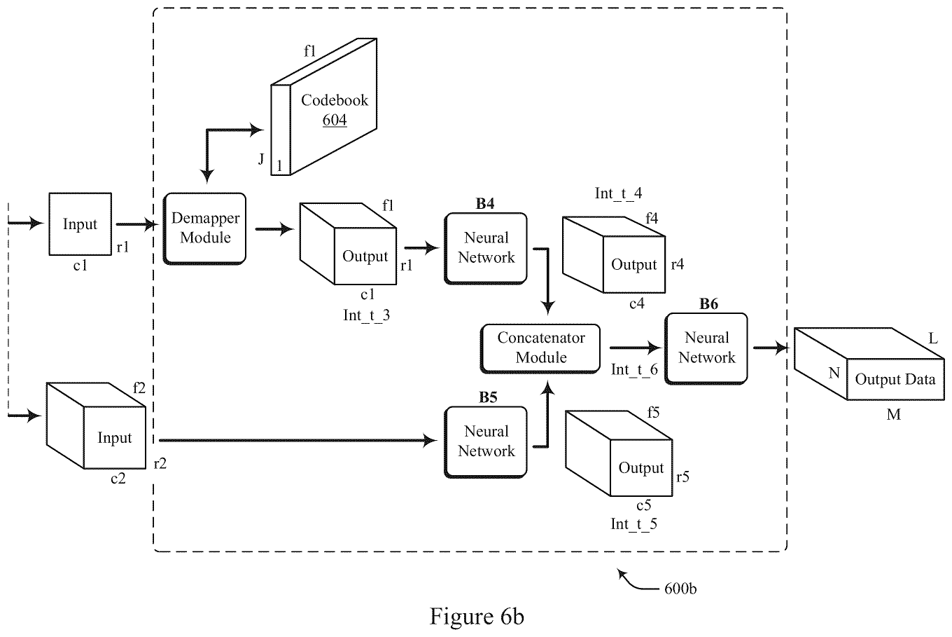

FIGS. 6a and 6b illustrate an example of a system, with a UE subsystem 600a and a network subsystem 600b that supports operation of a two-sided model, as related to training a node of a two-sided model in accordance with aspects of the present disclosure. In at least one implementation the UE subsystem 600a is implemented at a UE 104 and the network subsystem 600b is implemented at a network entity 102 (e.g., a gNB). In aspects of the described techniques, the UE side (e.g., the UE subsystem 600a) sends the latest H^{k} [n, m, l](t) to the gNB side (e.g., the network subsystem 600b). In this figure, blocks B1 to B6 are multilayer neural networks (NNs), which may also be referred to as an encoder model. The encoder part first generates two latent representations of the input data (i.e., Int_t_1 and Int_t_2). The encoder part then quantizes these latent representations using vector and value quantization methods, respectively. The results are then transmitted to the gNB side, where the decoder part (which includes multilayer NNs which may also be referred to as a decoder model) generates an output, such as the reconstruction of the input data. In this structure, the UE and gNB quantization codebook (602, 604) are assumed to be the same and their value along the weights of the NNs (for all blocks) will be learned during the training phase. Other hyperparameters like a value of J and the number of quantization levels (Q) for the quantizer module 606 can also be set during the training phase. Noting that the described structure, the input/output, and the 3D shape of blocks are for the purpose of illustration and any other structure can be used for the two-sided model.

Assuming that a set of first and second nodes are already trained and working, the techniques discussed herein describe methods to training a new first and/or second nodes or updating of one of the first and/or second nodes.

It should be noted that the techniques discussed herein are not related only to two-sided models used for channel state information (CSI) feedback but are applicable for training of two-sided models in a general case.

One main reason for separate model training is that the first and second nodes can use a model that they have designed (e.g., a manufacturer or vendor of the first or second nodes) and customized themselves and not just run a model that it provided by another vendor. This also gives protection on the design of the NN models of each node since the first and second nodes do not need to share the models with other parties.

Several methods can be used for separate training of a two-sided model. The discussion herein refers to a general case of a few first nodes and a few second nodes. However, it is to be appreciated that all of the discussion can be applied when there is only one first node and/or only one second node as well.

In one or more implementations for separate training of a model starts by training of the model at the first-nodes (e.g., UEs) first and then training of the model at the second nodes (e.g., network (NW) side), also referred to as first-node-first. In this scheme, the first-nodes (e.g., UE) first trains the encoder part by assuming a model for the decoder part, and this assumed model for the decoder part is also referred to as the nominal decoder (or a local decoder). Note that the nominal decoder part can be different from the actual decoder model at the second nodes. After completion of the training, the first node generates a dataset composed of samples from the output of the encoder (which can be considered as the input of the decoder part) and the expected output of the decoder. Sending this dataset to the second nodes, the second-node can train the decoder part based on the model structure determined by the second-node.

Another method for first-node-first separate training is that instead of generating a dataset for the second node, the first node transmits information regarding the trained nominal decoder so the second-node can train the actual decoder to match the input/output relation of the assumed (nominal) decoder.

In one or more implementations the training can start by training at the second nodes (e.g., NW side) first and then training of the model at the first node (e.g., UE side), also referred to as second-node-first. In this scheme, the second-node (e.g., gNB) first trains the decoder part by assuming a model for the encoder part, and this assumed model for the encoder part is also referred to as the nominal encoder (or a local encoder). Note that the nominal encoder part can be different from the model of the actual encoder part at the first node. After completion of the training, the second node generates a dataset composed of samples from the nominal input of the nominal encoder (which can be considered as the input of the encoder part) and the output of the nominal encoder (which can be considered as the expected output of the encoder part). Sending this dataset to the first nodes, the first-nodes can train the encoder part based on the model structure determined by the first-nodes.

Additionally or alternatively, one possibility is that instead of generating a dataset for the first node, the second node can transmit information regarding the trained “nominal encoder” to the first node, so the first-node can train the actual encoder to match the input/output relation of the assumed encoder.

Another extension can iterative first-node first and second-node first. In these methods after the first round of training the second nodes (or first nodes), further information is transmitted to the first nodes (or second nodes) so each first node (or second node) can update its nominal decoder (or nominal encoder) to be a better match with the actual decoder (or actual encoder) and fine tune the encoder (or decoder) based on the updated nominal decoder (or nominal encoder). This process can be repeated for multiple times.

The above schemes or implementations are mainly targeting initial training of a few first and second nodes together. In some scenarios there are a few first and second nodes that are already trained and they are working. Assume that a new first node or a new second node is to be added to the system. An issue is how this newly added first or second node is trained.

One solution is to follow the same steps as described above and retrain all first and second nodes (with addition of the new first or second node). However, this method incurs high complexity, large overhead and some delay.

Another solutions is to use simultaneous training, by freezing the weight of the existing encoder/decoder and train the decoder/encoder of the newly added nodes using simultaneous training. However, this method needs the existence of both the first node and second node in each training epoch, so it is not a separate training scheme which leads to some complexity for training when the owners of the first and second nodes are different.

The techniques discussed herein describe schemes to train such newly added nodes with one or both of low overhead or low complexity while keeping the benefit of separate training.

The discussions below use the following terminologies:
1— [symbol] ₑᵢ for i={0, 1, . . . , K−1} denotes the encoder model of the i^{th} first node (e.g., i^{th} UE)
2— [symbol] Idi for i={0, 1, . . . , K−1} denotes the nominal decoder model (if exists) of the i^{th} first node (e.g., i^{th} UE)
3— [symbol] _{dj} for j={0, 1, . . . , L−1} denotes the decoder model of the j^{th} second node (e.g., j^{th} gNB)
4— [symbol] ₑⱼ for j={0, 1, . . . , L−1} denotes the nominal encoder model (if exists) of the j^{th} second node (e.g., j^{th} gNB)

It is assumed that all K first-nodes and L second-nodes are trained and the system is working (e.g., data is being properly encoded, transmitted, and decoded). So, [symbol] ₑⱼ for i={0, 1, 2, . . . , K−1} and [symbol] _{dj} for j={0, 1, 2, . . . , L−1} are already trained.

With respect to addition of a new first node, upon addition of a new first-node, e.g., the K^{th} first-node, the new first-node determines [symbol] ₑₖ such that it is a proper match with the already trained [symbol] _{dj} for j={0, 1, 2, . . . , L−1}.

The new first-node obtains a training dataset for training of [symbol] _{eK}.

In one or more implementations, the new first node sends a request to the second nodes it wants to (expects or desires to) connect to so those second nodes send the training dataset to the new first node. Additionally or alternatively, the new first node sends a request to another node, e.g., which act as the organizer, and that node directly sends the dataset to the new first node or asks one or more of the second nodes or another node to send the requested dataset to the new first node. The new first node may specify the set of the second nodes it wants to connect to, or the organizer node can determine the way the training dataset is to be constructed, e.g., which of the second-nodes are to be configured to send training data to the new first-node.

This approach is similar to the first-node first approach discussed above. In this scheme, the new first-node first determines and trains a nominal decoder using the dataset it receives from the one or more of the second-nodes, organizer node, or other node.

The dataset associated to the j^{th} second-node can be represented by [symbol] ⱼ={<zₗ, ôₗ= [symbol] _{dj} (zₗ))}. Note that the samples zₗ can be from the set of samples that j^{th} second-node already received from the other first nodes, or can be from the set of samples the j^{th} second-node used for training of its [symbol] _{dj}.

Receiving [symbol] ⱼ from one or more second-nodes, an organizer node, or other nodes, the new first-node trains a nominal decoder based on the collection of all received [symbol] ⱼs, [symbol] _{dK}. Note that the j^{th} second node may additionally or alternatively send other information to the new first-node such that the new first-node can construct the nominal decoder. For example, the j^{th} second node can send [symbol] _{d} directly or send another model similar to [symbol] _{dj}. In such cases, the new first-node for example can train [symbol] _{dK} using a teacher student network scheme.

Having the trained [symbol] _{dK}, the new first-node trains the [symbol] _{eK} using the trained [symbol] _{dK}. For this, the new first-node constructs a model by constructing a local two-sided model, e.g., [symbol] _{eK}− [symbol] _{dK}, freezing the weight of [symbol] _{dK}, the new first-node determines the weights of [symbol] _{eK}, such that \hat{x}ₗ= [symbol] _{dK}( [symbol] _{eK}(xₗ)) is as close as possible to xₗ.

In one or more implementations, an approach similar to the second-node first approach is taken. In this scheme, the new first-node directly trains the encoder part, e.g., [symbol] _{eK}, using the dataset the new first-node receives from the one or more of the second-nodes, the organizer node, or another node.

The dataset associated to the j^{th} second-node is represented by [symbol] ⱼ={ [symbol] xₗ, zₗ= [symbol] ₑⱼ (xₗ) [symbol] }. This scheme is possible if the second-nodes have access to [symbol] ₑⱼ.

Note that the samples xₗ can be from the set of input samples, or can be from the set of samples the j^{th} second-node used for training of its [symbol] ₑⱼ.

Receiving [symbol] ⱼ from one or more second-nodes, or an organizer node, the new first-node can train the encoder based on the collection of all received [symbol] ⱼs. For example, such that \hat{z}ₗ= [symbol] _{eK}(xₗ)) becomes as close as possible to zₗ.

It should be noted that the j^{th} second node can additionally or alternatively send another information to the new first-node such that the new first-node can construct the encoder. For example, the j^{th} second node can send [symbol] ₑⱼ directly or send another model similar to [symbol] ₑⱼ. In such cases, the new first-node for example can train [symbol] _{eK} using a teacher student network scheme.

With respect to addition of a new second node, upon addition of a new second-node, e.g., the L^{th} second-node, the new second-node determines [symbol] _{dL} such that it is a proper match with the already trained [symbol] ₑᵢ for i={0, 1, 2, . . . , K−1}.

The new second-node obtains a training dataset for training of [symbol] _{dL}.

In one or more implementations, the new second node sends a request to the first nodes it wants to (expects or desires to) connect to so those first nodes send the training dataset to the new second node. Additionally or alternatively, the new second node sends a request to another node, e.g., which act as the organizer and that node directly sends the dataset to the new second node or asks one or more of the first nodes or another node to send the requested dataset to the new second node. The new second node may specify the set of the first nodes it wants to connect to, or the organizer node can determine the way the training dataset is to be constructed, e.g., which of the first-nodes are to be configured to send training data to the new second-node.

This approach is similar to the second-node first approach discussed above. In this scheme, the new second-node first determines and trains a nominal encoder using the dataset it receives from the one or more of the first-nodes, the organizer node, or other node.

The dataset associated to the i^{th} first-node can be represented by [symbol] ᵢ={ [symbol] (xₗ, \hat{z}ₗ= [symbol] ₑᵢ(xₗ) [symbol] }. Note that the samples xₗ can be from the set of samples that i^{th} first-node already used for training of its [symbol] ₑᵢ.

Receiving [symbol] ᵢ from one or more first-nodes, an organizer node, or other nodes, the new second-node trains a nominal encoder based on the collection of all received [symbol] ᵢs, [symbol] _{eL}. Note that the i^{th} first node may additionally or alternatively send another information to the new second-node such that new second-node can construct the nominal encoder. For example, the i^{th} first node can send [symbol] ₑᵢ directly or send another model similar to [symbol] ₑᵢ. In such cases, the new second-node for example can train [symbol] _{eL} using a teacher student network scheme.

Having the trained [symbol] _{eL}, the new second-node trains the [symbol] _{dL} using the trained [symbol] _{eL}. For this, the new second-node constructs a model by constructing a local two-sided model, e.g., [symbol] _{eL}− [symbol] _{dL}, freezing the weight of [symbol] _{eL}, the new second-node determines the weights of [symbol] _{eK}, such that \hat{x}ₗ= [symbol] _{dL}( [symbol] _{eL}(xₗ)) is as close as possible to xₗ.

In one or more implementations, the new second-node directly trains the decoder part, e.g., [symbol] _{dL}, using the dataset the new second-node receives from the one or more of the first-nodes, an organizer node, or other node. The dataset associated to the i^{th} first-node can be represented by [symbol] ᵢ={ [symbol] z₁= [symbol] ₑᵢ(xₗ), Oᵢ [symbol] }, where Oᵢ is the expected output associated with xₗ, in some implementations Oᵢ=xₗ. Note that the samples xₗ can be from the set of samples the i^{th} first-node used for training of its [symbol] ₑᵢ. Receiving [symbol] ᵢ from one or more second-nodes, an organizer node, or other node, the new second-node can train its decoder based on the collection of all received [symbol] ᵢs, such that Ôₗ= [symbol] _{dL}(zₗ) becomes as close as possible to Oₗ

With respect to iterative training and updating of the other models, after a new first-node or a new second-node is added to the system (trained its local model), the new first-node or new second-node can send some information to the other side so nodes on the other side can update their models considering the existence of the new node. After updating the process can be repeated again so the new node updates its models and continues the same.

In one or more implementations, if the model of one of the existing nodes gets updated, the existing node propagates the updated dataset to other nodes so they update their models accordingly.

It should be noted that in some of the discussions herein the existence of multiple first-nodes and second-nodes in the initial setup is assumed, but this is not a limiting factor and the techniques discussed herein are applicable to situations where there is one or both of only one first-node or only one second-node.

In one or more implementations, if there is more than one node to be added, the nodes can be added sequentially one-by-one or added at the same time analogous to the techniques discussed above.

Focusing on a separate training of a two-sided model, techniques are discussed herein for training of one or both of a new first-node or a new second-node added to an existing set of first and second nodes.

The techniques discussed herein are aligned with an assumption of separate training. The two sides do not need to know the model of the other side. Also, the techniques discussed herein do not need the participation of the first-node and the second-node during the training of each side. This property is ensured by exchanging of the datasets (e.g., not gradients).

The techniques discussed herein is elaborated for different approaches of first-node first and second-node first.

The techniques discussed herein can be used in conjunction with an iterative approach to improve the performance of the newly added node and also the other nodes. The overhead of such iteration is only during the training so it does not affect the performance during the inference time.

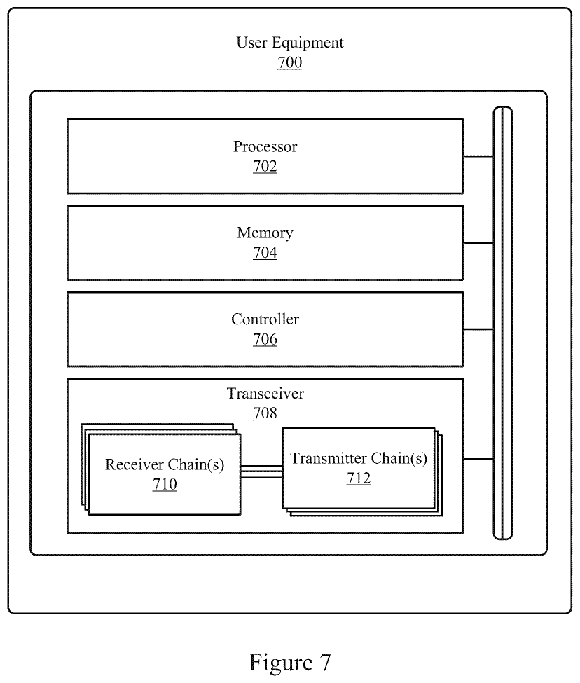

FIG. 7 illustrates an example of a UE 700 in accordance with aspects of the present disclosure. The UE 700 may also be referred to as a node (e.g., a first-node). The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to support a means for sending, to at least one network node, a first signaling indicating a request for training information that represents a trained model at a set of one or more base stations; receiving, from the at least one network node, at least one second signaling indicating the training information; and transmitting, to a base station of the set of one or more base stations, a third signaling indicating data encoded at the first node using an encoder trained based at least in part on the training information.

Additionally, the UE 700 may be configured to support any one or combination of: where the first node comprises a UE; where the encoder is trained using a local decoder at the first node, the local decoder having been trained using the training information; where the request contains information to identify the base stations included in the set of one or more base stations from which the first node wants to receive the training information; where the at least one network node includes the set of one or more base stations; combining the training information for multiple base stations of the set of one or more base stations, the encoder being trained based at least in part on the combined training information; where the training information includes at least one of a set of samples representing an input and an output of a decoder model of a two-sided model that includes the encoder, or characterizing information regarding the decoder model of the two-sided model; training, using the training information, a local decoder model to represent the decoder model of the two-sided model, and the encoder is trained using the local decoder model; where a first set of parameters of the encoder is determined such that the encoder sequentially combined with the trained local decoder model constructs an additional two-sided model that can generate input/output pairs similar to the input and the output; where the training information includes at least one of a set of samples representing an input and an output of a local encoder model, which performs as an encoder model of a local two-sided model of a base station, or characterizing information regarding the local encoder model; where a first set of parameters of the encoder model is determined such that the trained encoder model generates similar input/output pairs to input/output pairs generated by the local encoder model associated with the base station; where the first set of parameters comprises at least one of a structure or a weight of at least one neural network model; where the first set of parameters comprises at least one of a structure or a weight of at least one neural network model.

Additionally or alternatively, the UE 700 may support to: send, to at least one network node, a first signaling indicating a request for training information that represents a trained model at a set of one or more base stations; receive, from the at least one network node, at least one second signaling indicating the training information; and transmit, to a base station of the set of one or more base stations, a third signaling indicating data encoded at the first node using an encoder trained based at least in part on the training information.

Additionally, the UE 700 may be configured to support any one or combination of: where the first node comprises a UE; where the encoder is trained using a local decoder at the first node, the local decoder having been trained using the training information; where the request contains information to identify the base stations included in the set of one or more base stations from which the first node wants to receive the training information; where the at least one network node includes the set of one or more base stations; combine the training information for multiple base stations of the set of one or more base stations, the encoder being trained based at least in part on the combined training information; where the training information includes at least one of a set of samples representing an input and an output of a decoder model of a two-sided model that includes the encoder, or characterizing information regarding the decoder model of the two-sided model; train, using the training information, a local decoder model to represent the decoder model of the two-sided model, and the encoder is trained using the local decoder model; where a first set of parameters of the encoder is determined such that the encoder sequentially combined with the trained local decoder model constructs an additional two-sided model that can generate input/output pairs similar to the input and the output; where the training information includes at least one of a set of samples representing an input and an output of a local encoder model, which performs as an encoder model of a local two-sided model of a base station, or characterizing information regarding the local encoder model; where a first set of parameters of the encoder model is determined such that the trained encoder model generates similar input/output pairs to input/output pairs generated by the local encoder model associated with the base station; where the first set of parameters comprises at least one of a structure or a weight of at least one neural network model; where the first set of parameters comprises at least one of a structure or a weight of at least one neural network model.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

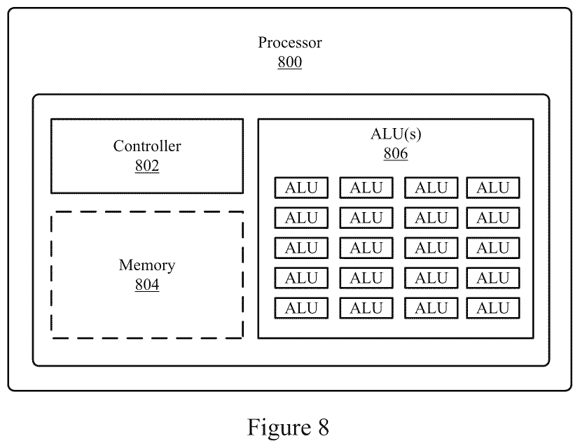

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to: send, to at least one network node, a first signaling indicating a request for training information that represents a trained model at a set of one or more base stations; receive, from the at least one network node, at least one second signaling indicating the training information; and transmit, to a base station of the set of one or more base stations, a third signaling indicating data encoded at a first node using an encoder trained based at least in part on the training information.

Additionally, the processor 800 may be configured to support any one or combination of: where the processor is implemented in a UE; where the encoder is trained using a local decoder at a first node that includes the processor, the local decoder having been trained using the training information; where the request contains information to identify the base stations included in the set of one or more base stations from which the a first node that includes the processor wants to receive the training information; where the at least one network node includes the set of one or more base stations; combine the training information for multiple base stations of the set of one or more base stations, the encoder being trained based at least in part on the combined training information; where the training information includes at least one of a set of samples representing an input and an output of a decoder model of a two-sided model that includes the encoder, or characterizing information regarding the decoder model of the two-sided model; train, using the training information, a local decoder model to represent the decoder model of the two-sided model, and the encoder is trained using the local decoder model; where a first set of parameters of the encoder is determined such that the encoder sequentially combined with the trained local decoder model constructs an additional two-sided model that can generate input/output pairs similar to the input and the output; where the training information includes at least one of a set of samples representing an input and an output of a local encoder model, which performs as an encoder model of a local two-sided model of a base station, or characterizing information regarding the local encoder model; where a first set of parameters of the encoder model is determined such that the trained encoder model generates similar input/output pairs to input/output pairs generated by the local encoder model associated with the base station; where the first set of parameters comprises at least one of a structure or a weight of at least one neural network model; where the first set of parameters comprises at least one of a structure or a weight of at least one neural network model.

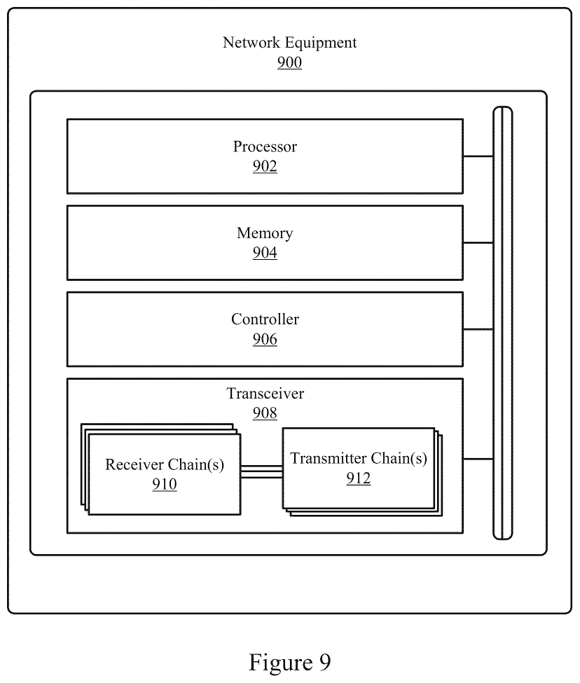

FIG. 9 illustrates an example of a NE 900 in accordance with aspects of the present disclosure. The NE 900 may also be referred to as a network node or a node (e.g., a second-node). The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to support a means for sending, to at least one network node, a first signaling indicating a request for training information associated with a set of one or more UEs; receiving, from the at least one network node, at least one second signaling indicating the training information; receiving, from a first UE of the set of one or more UEs, a third signaling indicating data encoded at the first UE; and decoding, using a decoder trained based at least in part on the training information, the data encoded at the first UE.

Additionally, the NE 900 may be configured to support any one or combination of where the first node comprises a base station; where the decoder is trained using a local encoder at the first node, the local encoder having been trained using the training information; where the request contains information to identify the UEs included in the set of one or more UEs from which the first node wants to receive the training information; where the at least one network node includes the set of one or more UEs; combining the training information for multiple UEs of the set of one or more UEs, the decoder being trained based at least in part on the combined training information; where the training information includes at least one of a set of samples representing an input and an output of an encoder model of a two-sided model that includes the decoder, or characterizing information regarding the encoder model of the two-sided model; training, using the training information, a local encoder model to represent the encoder model of the two-sided model, and the decoder is trained using the local encoder model; where a first set of parameters of the encoder is determined such that the encoder sequentially combined with the trained local decoder model constructs an additional two-sided model that can generate input/output pairs similar to the input and the output; where the training information includes at least one of a set of samples representing an output of an encoder model of a two-sided model and an expected output of a decoder model of the two-sided model; where a first set of parameters of the encoder model is determined such that the trained decoder model generates similar input/output pairs to input/output pairs included in the training information; where the first set of parameters comprises at least one of a structure or a weight of at least one neural network model; where the first set of parameters comprises at least one of a structure or a weight of at least one neural network model.

Additionally, or alternatively, the NE 900 may support to: send, to at least one network node, a first signaling indicating a request for training information associated with a set of one or more UEs; receive, from the at least one network node, at least one second signaling indicating the training information; receive, from a first UE of the set of one or more UEs, a third signaling indicating data encoded at the first UE; and decode, using a decoder trained based at least in part on the training information, the data encoded at the first UE.

Additionally, the NE 900 may be configured to support any one or combination of: where a first node comprises a base station; where the decoder is trained using a local encoder at the first node, the local encoder having been trained using the training information; where the request contains information to identify the UEs included in the set of one or more UEs from which the first node wants to receive the training information; where the at least one network node includes the set of one or more UEs; combine the training information for multiple UEs of the set of one or more UEs, the decoder being trained based at least in part on the combined training information; where the training information includes at least one of a set of samples representing an input and an output of an encoder model of a two-sided model that includes the decoder, or characterizing information regarding the encoder model of the two-sided model; train, using the training information, a local encoder model to represent the encoder model of the two-sided model, and the decoder is trained using the local encoder model; where a first set of parameters of the encoder is determined such that the encoder sequentially combined with the trained local decoder model constructs an additional two-sided model that can generate input/output pairs similar to the input and the output; where the training information includes at least one of a set of samples representing an output of an encoder model of a two-sided model and an expected output of a decoder model of the two-sided model; where a first set of parameters of the encoder model is determined such that the trained decoder model generates similar input/output pairs to input/output pairs included in the training information; where the first set of parameters comprises at least one of a structure or a weight of at least one neural network model; where the first set of parameters comprises at least one of a structure or a weight of at least one neural network model.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

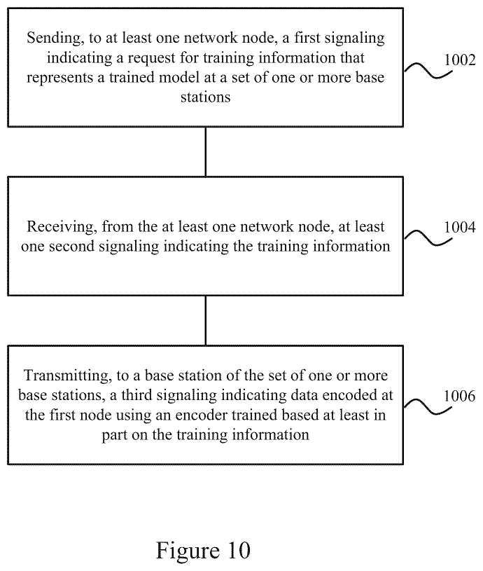

FIG. 10 illustrates a flowchart of a method in accordance with aspects of the present disclosure. The operations of the method may be implemented by a node (e.g., a UE) as described herein. In some implementations, the UE may execute a set of instructions to control the function elements of the UE to perform the described functions.

At 1002, the method may include sending, to at least one network node, a first signaling indicating a request for training information that represents a trained model at a set of one or more base stations. The operations of 1002 may be performed in accordance with examples as described herein. In some implementations, aspects of the operations of 1002 may be performed by a UE as described with reference to FIG. 7.

At 1004, the method may include receiving, from the at least one network node, at least one second signaling indicating the training information. The operations of 1004 may be performed in accordance with examples as described herein. In some implementations, aspects of the operations of 1004 may be performed by a UE as described with reference to FIG. 7.

At 1006, the method may include transmitting, to a base station of the set of one or more base stations, a third signaling indicating data encoded at the first node using an encoder trained based at least in part on the training information. The operations of 1006 may be performed in accordance with examples as described herein. In some implementations, aspects of the operations of 1006 may be performed a UE as described with reference to FIG. 7.

It should be noted that the method described herein describes a possible implementation, and that the operations and the steps may be rearranged or otherwise modified and that other implementations are possible.

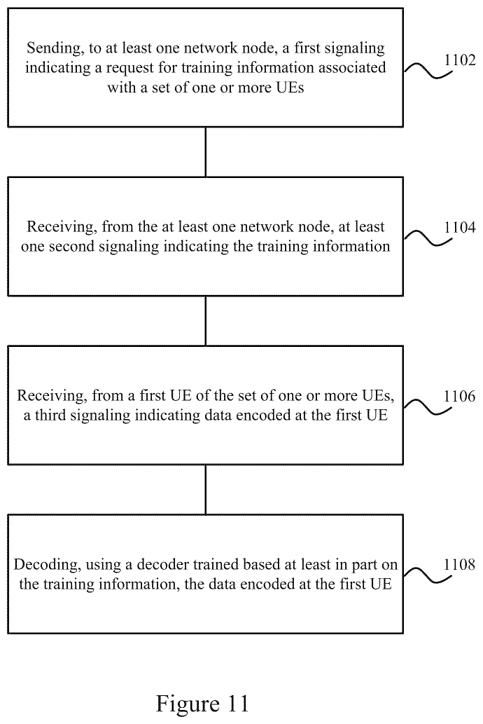

FIG. 11 illustrates a flowchart of a method in accordance with aspects of the present disclosure. The operations of the method may be implemented by a node or network node (e.g., a NE) as described herein. In some implementations, the NE may execute a set of instructions to control the function elements of the NE to perform the described functions.

At 1102, the method may include sending, to at least one network node, a first signaling indicating a request for training information associated with a set of one or more UEs. The operations of 1102 may be performed in accordance with examples as described herein. In some implementations, aspects of the operations of 1102 may be performed by a NE as described with reference to FIG. 9.

At 1104, the method may include receiving, from the at least one network node, at least one second signaling indicating the training information. The operations of 1104 may be performed in accordance with examples as described herein. In some implementations, aspects of the operations of 1104 may be performed by a NE as described with reference to FIG. 9.

At 1106, the method may include receiving, from a first UE of the set of one or more UEs, a third signaling indicating data encoded at the first UE. The operations of 1106 may be performed in accordance with examples as described herein. In some implementations, aspects of the operations of 1106 may be performed a NE as described with reference to FIG. 9.

At 1108, the method may include decoding, using a decoder trained based at least in part on the training information, the data encoded at the first UE. The operations of 1108 may be performed in accordance with examples as described herein. In some implementations, aspects of the operations of 1108 may be performed a NE as described with reference to FIG. 9.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node for wireless communication, comprising:
at least one memory; and
at least one processor coupled with the at least one memory and configured to cause the first node to:
send, to at least one network node, a first signaling indicating a request for training information that represents a trained model at a set of one or more base stations;
receive, from the at least one network node, at least one second signaling indicating the training information; and
transmit, to a base station of the set of one or more base stations, a third signaling indicating data encoded at the first node using an encoder trained based at least in part on the training information.

2. The first node of claim 1, wherein the first node comprises a user equipment (UE).

3. The first node of claim 1, wherein the encoder is trained using a local decoder at the first node, the local decoder having been trained using the training information.

4. The first node of claim 1, wherein the request contains information to identify the base stations included in the set of one or more base stations from which the first node wants to receive the training information.

5. The first node of claim 1, wherein the at least one processor is configured to combine the training information for multiple base stations of the set of one or more base stations, the encoder being trained based at least in part on the combined training information.

6. The first node of claim 1, wherein the training information includes at least one of a set of samples representing an input and an output of a decoder model of a two-sided model that includes the encoder, or characterizing information regarding the decoder model of the two-sided model.

7. The first node of claim 6, wherein the at least one processor is configured to cause the first node to train, using the training information, a local decoder model to represent the decoder model of the two-sided model, and the encoder is trained using the local decoder model.

8. The first node of claim 7, wherein a first set of parameters of the encoder is determined such that the encoder sequentially combined with the trained local decoder model constructs an additional two-sided model that can generate input/output pairs similar to the input and the output of a set of training data.

9. The first node of claim 1, wherein the training information includes at least one of a set of samples representing an input and an output of a local encoder model, which performs as an encoder model of a local two-sided model of a base station, or characterizing information regarding the local encoder model.

10. The first node of claim 9, wherein a first set of parameters of the encoder model is determined such that the trained encoder model generates similar input/output pairs to input/output pairs generated by the local encoder model associated with the base station.

11. The first node of claim 8, wherein the first set of parameters comprises at least one of a structure or a weight of at least one neural network model.

12. The first node of claim 10, wherein the first set of parameters comprises at least one of a structure or a weight of at least one neural network model.

13. A first node for wireless communication, comprising:
at least one memory; and
at least one processor coupled with the at least one memory and configured to cause the first node to:
send, to at least one network node, a first signaling indicating a request for training information associated with a set of one or more user equipments (UEs);
receive, from the at least one network node, at least one second signaling indicating the training information;
receive, from a first UE of the set of one or more UEs, a third signaling indicating data encoded at the first UE; and
decode, using a decoder trained based at least in part on the training information, the data encoded at the first UE.

14. The first node of claim 13, wherein the training information includes at least one of a set of samples representing an input and an output of an encoder model of a two-sided model that includes the decoder, or characterizing information regarding the encoder model of the two-sided model.

15. A processor for wireless communication, comprising:
at least one controller coupled with at least one memory and configured to cause the processor to:
send, to at least one network node, a first signaling indicating a request for training information that represents a trained model at a set of one or more base stations;
receive, from the at least one network node, at least one second signaling indicating the training information; and
transmit, to a base station of the set of one or more base stations, a third signaling indicating data encoded at the processor using an encoder trained based at least in part on the training information.

16. The processor of claim 15, wherein the encoder is trained using a local decoder at a first node that includes the processor, the local decoder having been trained using the training information.

17. The processor of claim 15, wherein the training information includes at least one of a set of samples representing an input and an output of a decoder model of a two-sided model that includes the encoder, or characterizing information regarding the decoder model of the two-sided model.

18. The processor of claim 15, wherein the training information includes at least one of a set of samples representing an input and an output of a local encoder model, which performs as an encoder model of a local two-sided model of a base station, or characterizing information regarding the local encoder model.

19. A method performed by a first node, the method comprising:
sending, to at least one network node, a first signaling indicating a request for training information that represents a trained model at a set of one or more base stations;
receiving, from the at least one network node, at least one second signaling indicating the training information; and
transmitting, to a base station of the set of one or more base stations, a third signaling indicating data encoded at the first node using an encoder trained based at least in part on the training information.

20. The method of claim 19, wherein the training information includes at least one of a set of samples representing an input and an output of a decoder model of a two-sided model that includes the encoder, or characterizing information regarding the decoder model of the two-sided model.
